(19) United States
(12) Patent Application Publication
(10) Pub. No.: US 2026/0265545 A1
(43) Pub. Date: Sep. 10, 2026

(54) METHOD FOR FORMING MULTILAYER COATING FILM, AND MULTILAYER COATING FILM THEREBY FORMED

(71) Applicant: BASF COATINGS GMBH, Muenster (DE)

(72) Inventors: Naoya SAKAI, Kanagawa (JP); Shigeyuki MIZUNO, Kanagawa (JP)

(21) Appl. No.: 18/872,043

(22) PCT Filed: Jun. 12, 2023
(86) PCT No.: PCT/EP2023/065655

§ 371 Date: Dec. 5, 2024

(30) Foreign Application Priority Data
Jul. 8, 2022 (JP) 2022-110728

(51) Int. Cl. C09D 5/36; B05D 1/02; B05D 1/36; B05D 3/00; C09D 7/40; C09D 7/65; C09D 175/04

(52) U.S. Cl. CPC C09D 5/36; B05D 1/02; B05D 1/36; B05D 3/007; C09D 7/65; C09D 7/69; C09D 175/04

(57) ABSTRACT

Disclosed herein are a method for forming a multilayer coating film in which a colored coating film layer that contains a color pigment is formed onto an object being coated, and a luster pigment-free top coat composition that contains a hydroxyl group-containing acrylic resin (A), a polyisocyanate compound (B), and resin beads (C) is applied thereon to form a top coat layer, which is cured, where the resin beads (C) have a specified average particle diameter D50, the dry film thickness of the top coat layer is equal to or less than the average particle diameter D50 of the resin beads (C), and the difference in the brightness (L*15−L*25) of the resulting multilayer coating film is within a specified range; and a multilayer coating film that has been formed by this method.

### TECHNICAL FIELD

The present invention relates to a method for forming a pearlescent multilayer coating film using a coating composition that contains no luster pigments such as interference pigments, and to a multilayer coating film formed by the method.

### BACKGROUND ART

Pearlescent paint colors, which contain optical interference pigments that change color depending on the angle of view, have recently gained in popularity as providing a sense of premium quality, particularly in fields such as automobile outer panels and household appliances. Pearlescent coating films of this sort can usually be obtained by applying a pearlescent coating composition, which contains an interference pigment defining the pearlescent texture, onto a colored base coating composition that defines the hue and lightness of the multilayer coating film, and applying a clear coating thereon to protect the coating film.

Patent Document 1, for example, discloses a method for forming a multilayer coating film by forming an electrodeposition coating film, a colored intermediate coating film, a luster coating film containing an interference pigment, and a clear coating film on an automobile body, wherein the use of a specific colored intermediate coating film allows a pearlescent heat-shielding multilayer coating film to be formed.

Meanwhile, attempts have been made to add resin beads to coating compositions for design purposes. Patent Document 2, for example, discloses a corrugated texture-forming powder coating material comprising a thermosetting powder coating component and resin beads. This powder coating can form a coating film having a soft, distinctive, satin-like corrugated texture in the form of a pattern of uniform, intricate, fine, rounded projections. Patent Document 3 discloses a paint-flatting method in which resin beads having a specific refractive index are added to a film-forming component capable of forming a clear layer. This method enables the formation of a top coat film that appears transparent and is less glossy.

### PRIOR ART DOCUMENTS

### Patent Documents

[Patent Document 1] Japanese Unexamined Patent Application No. 2016-36759
[Patent Document 2] Japanese Unexamined Patent Application No. 9-302272
[Patent Document 3] Japanese Unexamined Patent Application No. 5-65429

### SUMMARY OF THE INVENTION

### Problems to be Solved by the Invention

However, a clear coating film layer must be formed on the uppermost layer in the method for forming a multilayer coating film in Patent Document 1. The failure to form a clear coating layer on the uppermost layer would affect the weather resistance and moisture resistance of the resulting coating film, making it difficult to use outdoors. The invention in Patent Document 2 is a thermosetting powder coating, thus resulting in the need for a high heating temperature of 150 to 280° C. Patent Document 3 discloses only the matting effect achieved by the addition of the resin beads, but other effects are not satisfactory.

An object of the present invention is to provide a method in which a top coat composition that contains no luster pigments such as interference pigments is used to form a pearlescent multilayer coating film that is cured at a low temperature and that has better weather-resistance and moisture-resistance, even without the formation of a clear coating film layer on the uppermost layer.

Another object of the present invention is to provide a multilayer coating film that has been formed by the above method for forming a multilayer coating film.

### Means for Solving the Problems

As a result of extensive research to solve the abovementioned problems, the inventors perfected the present invention upon finding that the problems are solved by: a method for forming a multilayer coating film in which a colored coating film layer that contains a color pigment is formed onto an object being coated, and a luster pigment-free top coat composition that contains a hydroxyl group-containing acrylic resin (A), a polyisocyanate compound (B), and resin beads (C) is applied thereon to form a top coat layer, which is cured, wherein the resin beads (C) have a specified average particle diameter D50, the dry film thickness of the top coat layer is equal to or less than the average particle diameter D50 of the resin beads (C), and the difference in the brightness (L*15−L*25) of the resulting multilayer coating film is within a specified range.

Specifically, in the present invention, the problems are solved by a method for forming a multilayer coating film, comprising:
Step (1): a step in which a colored coating composition that contains a color pigment is applied onto an object being coated to form a colored coating film layer;
Step (2): a step in which a luster pigment-free top coat composition that contains a hydroxyl group-containing acrylic resin (A), a polyisocyanate compound (B), and resin beads (C) is applied onto the colored coating film layer to form a top coat layer; and
Step (3): a step in the colored coating film layer formed in Step (1) and the top coat layer formed in Step (2) are cured by being heated, either separately or simultaneously, wherein
the average particle size D50 of the resin beads (C) is 20 to 70 μm,
the dry film thickness of the top coat layer is equal to or less than the average particle diameter D50 of the resin beads (C), and
the difference between the L*15 value and the L*25 value (L*15−L*25) is 1.0 to 20.0, where the L*15 value indicates lightness, per the CIE LAB color system, based on the spectral reflectivity of reflected light, where the incident light landing at a 45 degree angle relative to the perpendicular line to the surface of the resulting multilayer coating film is measured at a 15 degree angle (incident light direction) relative to the angle of specular reflection, and the L*25 value indicates lightness, per the CIE LAB color system, based on the spectral reflectivity of reflected light, where the incident light landing at a 45 degree angle relative to the perpendicular line to the surface of the resulting multilayer coating film is measured at a 25 degree angle (incident light direction) relative to the angle of specular reflection.

In the method for forming a multilayer coating film of the present invention, the total content of the resin beads (C) in the top coat composition is preferably 5 to 40 parts by mass per 100 parts by mass of the total non-volatile components of the hydroxyl-containing acrylic resin (A) and the polyisocyanate compound (B).

The method of the present invention is preferably a method for forming a multilayer coating film wherein the top coat composition comprises a color pigment.

The method of the present invention is preferably a method for forming a multilayer coating film wherein the top coat layer is cured by being heated to between 7° and 150° C.

The method of the present invention is preferably a method for forming a multilayer coating film wherein the L*45 value of the colored coating film layer is 70 to 95, and the infrared reflectance (IRSR) of the resulting multilayer coating film is 60% or more.

In the present invention, the problems are also solved by a multilayer coating film that has been obtained by the above method for forming a multilayer coating film.

### Effect of the Invention

In the method for forming a multilayer coating film of the present invention, a top coat composition that contains no luster pigments such as interference pigments can be used to form a pearlescent multilayer coating film that can be cured at a low temperature and that has better weather-resistance and moisture-resistance, even without the formation of a clear coating film layer on the uppermost layer. It is also possible to ensure that this multilayer coating film has a better heat shielding effect.

### BRIEF DESCRIPTION OF THE DRAWINGS

FIG. 1 is a schematic diagram illustrating the method for measuring the difference in lightness of the multilayer coating film of the present invention.

FIG. 1(a) illustrates specular reflection of light incident on a coating film, and FIG. 1(b) illustrates reflected light for determining lightness.

### MODES FOR CARRYING OUT THE INVENTION

### [Step (1)]

In Step (1) of the method for forming a multilayer coating film of the present invention, a colored coating composition containing a color pigment is first applied onto the object being coated to form a colored coating film layer.

[Object being Coated]

Examples of objects that can be coated using the method for forming a multilayer film coating of the present invention include, but are not particularly limited to, members made of metals such as iron, zinc, aluminum, and magnesium, members made of alloys of these metals, members on which these metals have been applied by plating or vapor deposition, and members made, for example, of glass, plastic, or a variety of foamed materials, among which steel materials and plastic materials that are used to build automobile bodies are preferred. These members can be treated by means of a degreasing treatment or surface treatment, for example, as needed.

A primer coating film can also be formed on the members noted above when used as the object being coated in the present invention. The primary coating film is applied to the surface of the member in order to hide the surface of the member or to make the member corrosion-resistant, rust-resistant, or adhesive, for example, and can be formed by applying and then curing or drying a primer coating. Examples of primer coating materials that can be used include, but are not particularly limited to, well-known materials such as electrodeposition coatings, solvent-based primers, and water-based primers.

### [Colored Coating Composition]

The colored coating composition used in the method for forming a multilayer coating film of the present invention comprises a resin component and a color pigment.

The resin component of the colored coating composition used in the present invention may be a thermosetting resin composition that is applied and then heated to form a coating film as a cross linking reaction progresses, or may be a thermoplastic resin composition that forms a coating film as the solvent volatilizes off.

Examples of thermosetting resin compositions include those comprising: a base resin such as acrylic resins, polyester resins, alkyd resins, and urethane resins, which have cross linkable functional groups such as hydroxyl groups; and a cross linking agent such as a melamine resin, urea resin, or polyisocyanate compound (including ones that are blocked). These can be used while dissolved or dispersed in a solvent such as an organic solvent and/or water. The content of the cross linking agent in the resin composition (base resin+cross linking agent) is not particularly limited, but is preferably 10 to 100 parts by mass, more preferably 20 to 80 parts by mass, and in particular preferably 30 to 60 parts by mass, per 100 parts by mass of the total amount of resin nonvolatile components.

Examples of thermoplastic resin compositions include those comprising a base resin having a mass-average molecular weight of 30,000 or more, such as acrylic resins, polyester resins, alkyd resins, urethane resins, polyolefin resins (including ones that are chlorinated and/or modified), and epoxy resins. These can be used while dissolved or dispersed in a solvent such as an organic solvent and/or water.

Examples of color pigments in the colored coating composition used in the present invention include: inorganic pigments such as titanium oxide pigments, iron oxide pigments, titanium yellow, or other composite oxide pigments; organic pigments such as azo pigments, quinacridone pigments, diketopyrrolopyrrole pigments, perylene pigments, perinone pigments, benzimidazolone pigments, isoindoline pigments, isoindolinone pigments, metal chelate azo pigments, phthalocyanine pigments, anthraquinone pigments, dioxazine pigments, threne pigments, and indigo pigments; and carbon black. The use of azo-based black pigments, perylene-based black pigments, and metal oxide black pigments, for example, rather than carbon black pigments is preferred because the resulting multilayer coating film will have better heat shielding effects. These color pigments may be used alone or in combinations of two or more.

The total content of color pigment(s) in the colored coating composition used in the present invention is not particularly limited, but is preferably 10 to 200 parts by mass, more preferably 30 to 180 parts by mass, and in particular preferably 50 to 160 parts by mass, per 100 parts by mass of the total amount of resin nonvolatile components used as vehicle.

The colored coating composition used in the present invention may also include a luster pigment. Examples of the luster pigment include uncolored or colored aluminum pigments, vapor-deposited metal flake pigments, optical interference pigments obtained by coating a transparent or translucent substrate with a metal oxide, and the like. These luster pigments may be used alone or in combinations of two or more.

The total content of luster pigment(s) in the colored coating composition used in the present invention is not particularly limited, but is preferably 0 to 2.0 parts by mass, more preferably 0 to 1.0 part by mass, and in particular preferably 0 to 0.5 part by mass, per 100 parts by mass of the total amount of resin nonvolatile components used as vehicle.

The following can furthermore be blended, as needed, in the colored coating composition that is used in the present invention: solvents such as organic solvents and/or water; a variety of additives used in coatings, such as rheology control agents, pigment dispersants, anti-settling agents, curing catalysts, defoamers, antioxidants, and UV absorbers; and extender pigments. Examples of organic solvents include those routinely used to produce colored coating compositions, such as: aromatic hydrocarbons such as toluene, xylene, and aromatic naphtha; ketones such as acetone, methyl ethyl ketone, and methyl amyl ketone; esters such as ethyl acetate, butyl acetate, 2-butoxyethyl acetate, pentyl acetate, and ethyl ethoxypropionate; alcohols such as isopropanol, butanol, and 2-butoxyethanol; ethers; aliphatic hydrocarbons including chlorinated hydrocarbons; or mixtures thereof. In cases where polyisocyanate compounds (including ones that are blocked) are used as cross linkers, the use of organic solvent alcohols or water should be avoided in order to ensure a smoother curing reaction.

The content of non-volatile components used when the colored coating composition of the present invention is applied is not particularly limited, but is preferably 10.0 to 65.0% by mass, more preferably 15.0 to 63.0% by mass, and in particular preferably 20.0 to 60.0% by mass.

The colored coating composition used in the present invention can be applied by a method such as electrostatic coating, air spraying, or airless spraying; the thickness of the cured colored coating film is not particularly limited, but is preferably 5 to 50 μm, more preferably 10 to 45 μm, and in particular preferably 15 to 40 μm.

The L*45 value indicating lightness per the CIE LAB color system (based on the spectral reflectivity of reflected light, where the incident light landing at a 45 degree angle relative to the perpendicular line to the surface of the resulting multilayer coating film is measured at a 45 degree angle (incident light direction) relative to the angle of specular reflection) is not particularly limited, but a value of 70 to 95 will ensure that the resulting multilayer coating film has a better heat shielding effect. The L*45 value is more preferably 75 to 93, and is in particular preferably 80 to 90. The CIE LAB color system is a color system that was specified by the International Commission on Illumination (CIE) in 1976; it is also adopted in JISZ 8781-4:2013. The lightness L*45 value in the present invention is a numerical value that is measured using the multi-angle spectrophotometer BYK-mac i (trade name, manufactured by BYK Gardner).

### [Step (2)]

In Step (2) of the method for forming a multilayer coating film of the present invention, the top coat composition is applied onto the colored coating layer to form the top coat layer.

### [Top Coat Composition]

The top coat composition used in the method to form the multilayer coating film of the present invention comprises a hydroxyl group-containing acrylic resin (A), a polyisocyanate compound (B), and resin beads (C), but does not contain a luster pigment.

### [Hydroxyl Group-Containing Acrylic Resin (A)]

The hydroxyl group-containing acrylic resin (A) used in the present invention can be obtained by a known method such as radical copolymerization of a monomer mixture comprising a hydroxyl group-containing acrylic monomer. Examples of hydroxyl group-containing acrylic monomers include: esters such as 2-hydroxyethyl, 2-hydroxypropyl, 3-hydroxypropyl, or 4-hydroxybutyl acrylates or methacrylates; and ε-caprolactone or ethylene oxide or propylene oxide ring opening adducts of 2-hydroxyethyl acrylate or methacrylate. These hydroxyl group-containing acrylic monomers may be used alone or in combinations of two or more.

Examples of other monomers than can be copolymerized with the above hydroxyl group-containing acrylic monomers include: acrylic acid or methacrylic acid, as well as methyl, ethyl, n-propyl, isopropyl, n-butyl, isobutyl, t-butyl, hexyl, cyclohexyl, 2-ethylhexyl, lauryl, and stearyl esters thereof; and acrylonitrile, methacrylonitrile, acrylamide, methacrylamide, styrene, α-methylstyrene, maleic acid, and vinyl acetate. These copolymerizable monomers may be used alone or in combinations of two or more with the above hydroxyl group-containing acrylic monomers.

The hydroxyl group value of the hydroxyl group-containing acrylic resin (A) is determined on the basis of the content of the hydroxyl group-containing acrylic monomer in the monomers that are to be copolymerized. The hydroxyl group value of the hydroxyl group-containing acrylic resin (A) used in the present invention is not particularly limited, but is preferably 80 to 200 mgKOH/g, more preferably 90 to 190 mgKOH/g, and in particular preferably 100 to 180 mgKOH/g.

The glass transition temperature of the hydroxyl group-containing acrylic resin (A) is determined on the basis of the proportions in which the monomers that are to be copolymerized have been blended. The glass transition temperature of the hydroxyl group-containing acrylic resin (A) used in the present invention is not particularly limited, but is preferably −50 to 70° C., more preferably −45 to 65° C., and in particular preferably −40 to 60° C. The glass transition temperature in the present invention is a numerical value calculated from the formula shown below.

$$1 / Tg = \sum ( Wi / Tgi )$$

$$Tg \text{:} copolymer glass transition temperature ( absolute temperature )$$

$$Wi \text{:} percentage by mass of monomer i component$$

$$Tgi \text{:} glass transition temperature ( absolute temperature ) of monomer i component homopolymer$$

The mass-average molecular weight of the hydroxyl group-containing acrylic resin (A) is determined on the basis of the reaction conditions during copolymerization. The mass-average molecular weight of the hydroxyl group-containing acrylic resin (A) used in the present invention is not particularly limited, but is preferably 2,000 to 20,000, more preferably 3,000 to 18,000, and in particular preferably 4,000 to 16,000. The mass-average molecular weight can be determined, for example, as the value calculated on the basis of the weight-average molecular weight of polystyrene from data obtained by gel permeation chromatography (GPC) at a temperature of 40° C. and a flow rate of 1 mL/min using tetrahydrofuran (THF) as the eluent. Here, the gel permeation chromatography (GPC) columns can be, for example, a combination of TSKgel G2000HXL, G3000HXL, G4000HXL, and G5000HXL (trade name, manufactured by Tosoh Corporation).

### [Polyisocyanate Compound (B)]

The polyisocyanate compound (B) used in the present invention is not particularly limited, provided that it is one used for coating applications, where a variety of polyisocyanate compounds such as aromatic, aliphatic, and alicyclic polyisocyanate compounds can be used. Preferred examples of such polyisocyanate compounds include toluene diisocyanate (TDI), 4,4′-diphenylmethane diisocyanate (MDI), xylene diisocyanate (XDI), hexamethylene diisocyanate (HDI), lysine diisocyanate (LDI), 2-isocyanatoethyl-2,6-diisocyanatocaproate (LTI), isophorone diisocyanate (IPDI), trimethylhexamethylene diisocyanate (TMDI), and hydrogenated xylene diisocyanate (H6XDI). Biurets, adducts, and isocyanurates of these may also be used, for example. Some of these isocyanate groups may be modified with an amino group-containing silane coupling agent, for example. These polyisocyanate compounds may be used alone or in combinations of two or more.

In the top coat composition used in the present invention, the proportion of isocyanate groups in the polyisocyanate compound (B) is preferably 0.4 to 1.6 mol, more preferably 0.6 to 1.4 mol, and in particular preferably 0.8 to 1.2 mol, per 1 mol of hydroxyl groups in the hydroxyl group-containing acrylic resin (A).

### [Resin Beads (C)]

The average particle size D50 of the resin beads (C) used in the present invention is preferably 20 to 70 μm, more preferably 30 to 65 μm, and in particular preferably 40 to 60 μm. An average particle size D50 of 20 μm or more will allow the pearlescent look to be improved, while an average particle size D50 of 70 μm or less can prevent spray guns from becoming clogged during the coating process.

As used in the present invention, the average particle size D50 is the particle size of 50% of the total volume of particles, from the smallest particle size to a given particle size, expressed as a percentage of the volume of all particles, in a cumulative particle size distribution determined by laser diffraction/scattering (static light scattering). Examples of devices for measuring particle size distribution by laser diffraction/scattering (static light scattering) include the Partica LA-960V2 series (trade name, manufactured by Horiba, Ltd.), SALD-2300 (trade name, manufactured by Shimadzu Corporation), and the MT3000II series (trade name, manufactured by MicrotracBel Corp.).

The resin beads (C) preferably have a spherical shape with a smooth surface but may have a quasi-spherical shape with a corrugated texture on the surface. However, the use of columnar or acicular shapes is not recommended, as the intended pearlescent look may be difficult to achieve. The resin beads (C) may have a cross linked or uncross linked structure, provided that the shape is stable during the heat curing process. The resin beads (C) may also contain, for example, colorants such as organic pigments and inorganic pigments, and stabilizers such as antioxidants and UV absorbers.

The resin composition or route of synthesis, for example, of the resin beads (C) is not particularly limited; beads of resins such as polyamide (nylon) resins, polyolefin resins, acrylic resins, polystyrene resins, epoxy resins, polyester resins, urethane resins, and melamine resins can be used. Typical examples of commercially available resin beads include: VESTOSCINT 1164 and VESTOSCINT 2157 (trade name, manufactured by Daicel-Evonik Ltd.); ORGASOL 1002 D NAT1, ORGASOL 1002 ES5 NAT1, ORGASOL 2002 D NAT1, ORGASOL 2002 ES3 NAT3, ORGASOL 2002 ES4 NAT3, ORGASOL 2002 ES5 NAT3, ORGASOL 2002 ES6 NAT3, and ORGASOL 3502 D NAT1 (trade name, manufactured by Arkema); MIPELON XM-220 and MIPELON XM-330 (trade name, manufactured by Mitsui Chemicals, Inc.), CHEMISNOW MX-2000, CHEMISNOW MX-3000, CHEMISNOW MZ-20HN, CHEMISNOW MZ-30H, CHEMISNOW SGP-70C, and CHEMISNOW SGP-150C (Product name, manufactured by Soken Chemical & Engineering); TECHPOLYMER MBX-20, TECHPOLYMER MBX-30, TECHPOLYMER MBX-40, TECHPOLYMER MBX-50, TECHPOLYMER MBX-60, TECHPOLYMER MB30X-20, TECHPOLYMER MB20X-30, TECHPOLYMER MBX-25H, TECHPOLYMER SSX-120, TECHPOLYMER SSX-127, TECHPOLYMER MBP-20, TECHPOLYMER SBX-30, TECHPOLYMER BM30X-30, TECHPOLYMER BM30X-55, TECHPOLYMER ABX-20, TECHPOLYMER ARX-30, TECHPOLYMER AFX-30, and TECHPOLYMER MB-20 (trade name, manufactured by Sekisui Kasei Co., Ltd.); and TAFTIC AR650M, TAFTIC AR650MX, TAFTIC AR650MZ, and TAFTIC FH-S020 (trade name, manufactured by Japan Exlan Co., Ltd.); and RUBCOLEUR 030 (X) Clear (trade name, manufactured by Dainichiseika Color & Chemicals Co., Ltd.). These resin beads may be used alone or in combinations of two or more.

In the top coat composition used in the present invention, the total content of resin beads (C) is preferably 5 to 40 parts by mass, more preferably 15 to 35 parts by mans, and in particular preferably 10 to 30 parts by mass, per 100 parts by mass total of the non-volatile components of the hydroxyl group-containing acrylic resin (A) and the polyisocyanate compound (B). A resin bead (C) content of 5 parts by mass or more will ensure that a distinctive design effect can be achieved, and a resin bead (C) content of up to 40 parts by mass will ensure weather resistance and moisture resistance.

The top coat composition used in the present invention may also include a color pigment. Examples of color pigments include: inorganic pigments such as titanium oxide pigments, iron oxide pigments, titanium yellow, or other composite oxide pigments; organic pigments such as azo pigments, quinacridone pigments, diketopyrrolopyrrole pigments, perylene pigments, perinone pigments, benzimidazolone pigments, isoindoline pigments, isoindolinone pigments, metal chelate azo pigments, phthalocyanine pigments, anthraquinone pigments, dioxazine pigments, threne pigments, and indigo pigments; and carbon black. The use of azo-based black pigments, perylene-based black pigments, and metal oxide black pigments, for example, rather than carbon black pigments is preferred because the resulting multilayer coating film will have better heat shielding effects. These color pigments may be used alone or in combinations of two or more.

The total color pigment content in the top coat composition used in the present invention is not particularly limited, but is preferably 0 to 50 parts by mass, more preferably 2 to 40 parts by mans, and in particular preferably 5 to 35 parts by mass, per 100 parts by mass total of the non-volatile components of the hydroxyl group-containing acrylic resin (A) and the polyisocyanate compound (B). However, the top coat composition of the present invention does not contain a luster pigment because the weather resistance and moisture resistance would presumably be compromised.

The following can furthermore be blended, as needed, in the top coat composition that is used in the present invention: solvents such as organic solvents; a variety of additives used in coatings, such as rheology control agents, pigment dispersants, anti-settling agents, curing catalysts, defoamers, antioxidants, and UV absorbers; and extender pigments. Examples of organic solvents include those routinely used to produce top coat compositions, such as: aromatic hydrocarbons such as toluene, xylene, and aromatic naphtha; ketones such as acetone, methyl ethyl ketone, and methyl amyl ketone; esters such as ethyl acetate, butyl acetate, 2-butoxyethyl acetate, pentyl acetate, and ethyl ethoxypropionate; ethers; aliphatic hydrocarbons including chlorinated hydrocarbons; or mixtures thereof. However, the use of alcohols is not recommended as the curing reaction may be hindered.

The content of non-volatile components used when the top coat composition of the present invention is applied is not particularly limited, but is preferably 56.0 to 72.0% by mass, more preferably 58.0 to 70.0% by mass, and in particular preferably 60.0 to 68.0% by mass.

The top coat composition used in the present invention can be applied by methods such as electrostatic coating, air spraying, and airless spraying.

The thickness of the cured top coat layer used in the present invention is preferably equal to or less than the average particle size D50 of the resin beads. Ensuring that the thickness (average thickness) of the cured top coat layer is equal to or less than the average particle size D50 of the resin beads will allow the pearlescent look to be improved. In particular, the thickness of the cured top coat layer is preferably 60 to 95%, and in particular preferably 65 to 80%, relative to the average particle size D50 of the resin beads. In the present invention, the cured thickness is the average of any 10 approximately equidistant points on a 10 cm×20 cm test piece measured using an electromagnetic film thickness meter DELTASCOPE FMP10 (trade name, manufactured by Helmut Fischer).

### [Step (3)]

In Step (3) of the method for forming the multilayer coating film of the present invention, the colored coating film layer formed in Step (1) and the top coat layer formed in Step (2) are heated, either separately or simultaneously, to obtain a cured multilayer coating film.

In the present invention, when the colored coating layer and the top coat layer are heated separately, the first heating is done between Step (1) and Step (2), and the second heating is done after Step (2). When separately heated, the conditions of the first heating and second heating may be the same or different.

In the present invention, heating is done only after Step (2) if the colored coating layer and the top coat layer are heated simultaneously. When heated simultaneously, preheating or air blowing, for example, can be done between Step (1) and Step (2), provided that the coating film is not substantially cured.

Of these options in the present invention, the following is preferred in the interests of the appearance, for example, of the multilayer coating film: the colored coating film layer is formed and is then allowed to stand at room temperature or is preheated, the top coat layer coating film is then formed thereon, and the colored coating film layer and top coat layer coating film are then simultaneously heated.

In the present invention, heating can be done by known means; for example, a drying furnace such as an air-heating furnace, electrical furnace, or infrared induction heating furnace can be used. The heating temperature is not particularly limited, but is preferably 70 to 150° C., more preferably 70 to 125° C., and in particular preferably 70 to 100° C. A heating temperature of 70° C. or higher can ensure that the curing reaction progresses well, while a temperature up to 150° C. will help to control energy consumption. The heating time is also not particularly limited, but is preferably 10 to 50 minutes, more preferably 15 to 40 minutes, and in particular preferably 20 to 30 minutes.

The multilayer coating film obtained by the method for forming a multilayer coating film in the present invention has a pearlescent look which changes color depending on the angle of view.

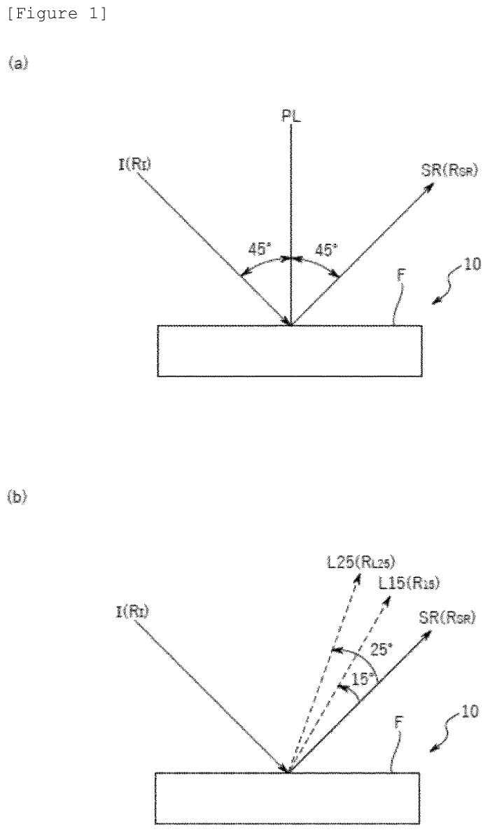

To obtain an exceptional pearlescent look, the difference in lightness L*15−L*25 of the multilayer coating film of the present invention is set to within a specific range as noted below. As noted above, the lightness L* is defined in JIS Z 8781-4:2013, and its use in the present invention is further illustrated below with reference to FIG. 1.

FIG. 1(a) is a cross-sectional view of the multilayer coating film 10, which shows light landing at a 45 degree angle relative to the perpendicular line PL to the coating film surface F of the multilayer coating film 10. When incident light I lands at an incident angle R_{I}45° relative to the perpendicular line PL to the coating film surface F and is specularly reflected at the coating film surface F, the reflection angle of the specularly reflected light SR, specifically, the angle of specular reflection Rₛᵣ, is perpendicular (90°) to the incident angle R_{I}.

In the present invention, the dry film thickness of the top coat layer is equal to or less than the average particle size D50 of the resin beads (C), thus resulting in the formation of a specific corrugated texture on the upper surface of the multilayer coating film 10. In order to give the multilayer coating film 10 a pearl-like appearance, the reflection of the surface F of the resulting coating film is kept within a certain range by, for example, selecting the dry film thickness of the multilayer coating film 10, the shape and average particle size D50 of the resin beads (C), and the total content of the resin beads (C) in the top coat composition, thereby ensuring that the multilayer coating film has an exceptional pearly luster.

As shown in FIG. 1(b), the incident light I that is reflected at an angle of 15 degrees (incident light direction) relative to the angle of specular reflection R_{SR} (reflected light L₁₅ (indicated by a broken line) at a reflection angle R_{L15}) is measured as L*15 (indicating lightness, per the CIE LAB color system, based on spectral reflectivity) by a measuring device (not shown).

The incident light I that is reflected at an angle of 25 degrees (incident light direction) relative to the angle of specular reflection R_{SR} (reflected light L₂₅ (indicated by a broken line) at a reflection angle R_{L25}) is measured as L*25 (indicating lightness, per the CIE LAB color system, based on spectral reflectivity) by a measuring device (not shown). The state of the surface, that is, the pearly appearance, of the multilayer coating film of the present invention is specified by the difference L*15−L*25 between the two lightness values at the two reflection angles measured in this manner.

The lightness L*15 value and L*25 value in the present invention are numerical values that are measured using the multi-angle spectrophotometer BYK-mac i (trade name, manufactured by BYK Gardner). In the multilayer coating film of the present invention, the difference in lightness L*15−L*25 is preferably 1.0 to 20.0, more preferably 1.5 to 15.0, and in particular preferably 2.0 to 10.0. A difference in lightness L*15−L*25 of 1.0 to 20.0 will ensure that the multilayer coating film has an exceptional pearlescent look.

The multilayer coating film obtained in the present invention also preferably has an infrared reflectance (IRSR) of 60% or more, more preferably 63% or more, and in particular preferably 65% or more. An infrared reflectance (IRSR) of 60% or more will ensure that the resulting multilayer coating film has a better heat shielding effect. Herein, the infrared reflectance (IRSR) in the present invention is a numerical value measured by using an ultraviolet/visible/near-infrared spectrophotometer UV-3600 (trade name, manufactured by Shimadzu Corporation).

The multilayer coating film obtained in the present invention has a total solar reflectance (TSR) that is preferably 60% or more, more preferably 63% or more, and in particular preferably 65% or more. A total solar reflectance (TSR) of 60% or more will ensure that the resulting multilayer coating film has a better heat shielding effect. As used in the present invention, the total solar reflectance (TSR) is a numerical value that is measured using an ultraviolet/visible/near-infrared spectrophotometer UV-3600 (trade name, manufactured by Shimadzu Corporation).

The method for forming a multilayer coating film, as well as the multilayer coating film thereby obtained, in the present invention are suitable for bodies, members, and parts of automobiles such as passenger cars, trucks, motorcycles, and buses, and are particularly effective for use in automobile bodies in cases where the object being coated is metal, and for use in interior and exterior parts of automobile bodies in cases where the object being coated is plastic.

### EXAMPLES

The present invention is described in greater detail by, but is not limited to, the following examples. In the examples, “parts” means “parts by mass” and the “%” of amounts that are blended and content means “% by mass,” unless otherwise specified.

### Production Example 1: Production of Polyurethane Resin Dispersion PU-1 for Water-Based Colored Coating Composition

### (1) Production of Polyester Polyol Solution PP-1

Into a flask equipped with a reflux condenser (with a separation tube for reaction water), a thermometer, a stirrer, and a nitrogen gas feed tube were charged 35.0 parts of the dimer acid PRIPOL 1017 (trade name, manufactured by Croda Japan; based on a C36 dicarboxylic acid produced by dimerization of a C18 unsaturated fatty acid), 30.0 parts of isophthalic acid, 0.6 part of adipic acid, 33.6 parts of 1,6-hexanediol, and 0.8 part of trimethylolpropane; the raw material contents were dissolved by being heated to 120° C., and were then heated to 160° C. while stirred. The contents were maintained at 160° C. for 1 hour and were then heated to 230° C. over a period of 5 hours. The acid value was periodically determined as the contents were maintained at 230° C.; when the resin acid value reached 4 mgKOH/g, the contents were cooled to at least 80° C. Lastly, 60.8 parts of methyl ethyl ketone was added, giving a polyester polyol solution PP-1. The polyester polyol solution PP-1 was characterized by a mass-average molecular weight of 7,200, an acid value of 4 mgKOH/g, a hydroxyl value of 62 mgKOH/g, and a resin solids content of 60%.

### (2) Production of Polyurethane Resin Dispersion PU-1

Into a flask equipped with a thermometer, stirrer, and nitrogen gas feed tube were charged 110.0 parts of the polyester polyol solution PP-1 obtained in Production Example 1-(1), 4.5 parts of dimethylolpropionic acid, 2.0 parts of neopentyl glycol, and 20.3 parts of methyl ethyl ketone, and the contents were heated to 80° C. while stirred. When the temperature had reached 80° C., 24.0 parts of isophorone diisocyanate was added, the temperature was maintained at 80° C.; when the isocyanate content reached 0.40 mmol/g, 3.2 parts of trimethylolpropane was added, and the temperature was maintained at 80° C. When the isocyanate content reached 0.03 mmol/g, 5.2 parts of butyl cellosolve was added; after the contents had cooled to 50° C., 3.3 parts of dimethylethanolamine was added to neutralize the acid groups, and 150.0 parts of deionized water was added. The contents were then heated to 100° C., and the methyl ethyl ketone was removed at reduced pressure, giving a polyurethane resin dispersion PU-1. The polyurethane resin dispersion PU-1 was characterized by a mass-average molecular weight of 71,000, an acid value of 21 mgKOH/g, a hydroxyl value of 21 mgKOH/g, and a resin solids content of 38%.

### Production Example 2: Production of Polyester Resin Solution PE-1 for Water-Based Colored Coating Composition

Into a flask equipped with a reflux condenser (with a separation tube for reaction water), a thermometer, a stirrer, and a nitrogen gas feed tube were charged 15.0 parts of the abovementioned dimer acid PRIPOL 1017 (trade name, manufactured by Croda Japan), 30.0 parts of isophthalic anhydride, 3.1 parts of adipic acid, 31.5 parts of 1,6-hexanediol, and 10.3 parts of trimethylolpropane; the raw material contents were dissolved by being heated to 120° C., and were then heated to 160° C. while stirred. The contents were maintained at 160° C. for 1 hour and were then heated to 230° C. over a period of 5 hours. The contents were maintained at 230° C. for 2 hours and were then heated to 180° C. 10 parts of trimellitic anhydride was then added, the acid value was periodically determined as the contents were maintained at 180° C.; when the acid value reached 25 mgKOH/g, the contents were cooled to at least 80° C. 25 parts of butyl cellosolve was added, 3.2 parts of dimethylethanolamine was added to neutralize the acid groups, and 34.1 parts of deionized water was added, giving a polyester resin solution PE-1. The polyester resin solution PE-1 was characterized by a mass-average molecular weight of 15,000, an acid value of 25 mgKOH/g, a hydroxyl value of 90 mgKOH/g, and a resin solids content of 60%.

### Production Example 3: Production of Water-Based Colored Coating Composition PR-1

### (1) Production of Water-Based Colored Coating Composition PR-1

To 26.3 parts of the polyurethane resin dispersion PU-1 (dispersion resin) and 33.3 parts of polyester resin solution PE-1 were added 119.0 parts of the titanium dioxide pigment Ti-Pure R706 (trade name, manufactured by Chemours), 1.0 part of the perylene-based black pigment Paliogen Black L0086 (trade name, manufactured by DIC Corporation), and 30.0 parts of deionized water (to adjust the viscosity); the contents were dispersed using a Motormill, giving a pigment paste. 52.6 parts of the polyurethane resin dispersion PU-1 was then weighed out, 209.6 parts of the above pigment paste was added, and the contents were mixed while stirred in a dissolver. To this were added and mixed 27.8 parts of the melamine resin solution CYMEL 203 (trade name, manufactured by Allnex; nonvolatile component content: 72% by mass), 12.5 parts of the melamine resin solution CYMEL 325 (trade name, manufactured by Allnex: nonvolatile component content: 80% by mass), 33.3 parts of the polyester resin solution PE-1, and 40.0 parts of deionized water. Lastly, the mixture was diluted with deionized water to a Ford #4 Cup viscosity of 40 seconds at 20° C., giving a water-based colored coating composition PR-1.

### (2) Assessment of Water-Based Colored Coating Film Layer

The cationic electrodeposition coating CathoGuard 500 (trade name, manufactured by BASF Japan) was applied via electrodeposition to a cured film thickness of 20 μm on a zinc phosphate-treated mild steel sheet, and was baked for 25 minutes at 175° C., giving an electrodeposition-coated sheet. The water-based colored coating composition PR-1 was then spray-coated to a dry film thickness of 30 μm on the electrodeposition-coated sheet, and was preheated for 5 minutes to 85° C. This was then heated for 30 minutes to 100° C., giving a water-based colored coating film layer. The lightness L*45 value of the resulting water-based colored coating film layer was 87, as determined using the multi-angle spectrophotometer BYK-mac i (trade name, manufactured by BYK Gardner).

### Production Example 4: Production of Solvent-Based Colored Coating Composition PR-2

### (1) Production of Solvent-Based Colored Coating Composition PR-2

To 200.0 parts of the maleic anhydride-modified chlorinated polypropylene resin solution SUPERCHLON 842LM (trade name, manufactured by Nippon Paper Industries; nonvolatile component content: 20% by mass; mass-average molecular weight: 55,000) as the resin dispersion were added 50.0 parts of toluene, 139.0 parts of the titanium dioxide pigment Ti-Pure R706 (trade name, manufactured by Chemours), and 1.0 part of the perylene-based black pigment Paliogen Black L0086 (trade name, manufactured by DIC Corporation); the contents were dispersed using a Motormill, giving a pigment paste. 200.0 parts of the maleic anhydride modified chlorinated polypropylene resin solution SUPERCHLON 842LM was then weighed out, 390.0 parts of the above pigment paste was added, and the contents were mixed while stirred in a dissolver. To this were added and mixed 13.3 parts of the blocked isocyanate resin solution Desmodur BL 3175 SN (trade name, manufactured by Sumika Covestro Urethane Co., Ltd.; nonvolatile component content: 75% by mass; NCO content: 11.1% by mass), 10.0 parts of the liquid epoxy resin jER 828 (trade name, manufactured by Mitsubishi Chemical Corporation), and 100.0 parts of the aromatic petroleum naphtha Solvesso 100 (trade name, ExxonMobil). Lastly, the resulting mixture was diluted with a solvent mixture (1:1 mass ratio) consisting of toluene/aromatic petroleum naphtha Solvesso 100 (trade name, ExxonMobil) to a Ford #4 Cup viscosity of 15 seconds at 20° C., giving a solvent-based colored coating composition PR-2.

### (2) Assessment of Solvent-Based Colored Coating Film Layer

The cationic electrodeposition coating CathoGuard 500 (trade name, manufactured by BASF Japan) was applied via electrodeposition to a cured film thickness of 20 μm on a zinc phosphate-treated mild steel sheet, and was baked for 25 minutes at 175° C., giving an electrodeposition-coated sheet. The solvent-based colored coating composition PR-2 was then spray-coated to a dry film thickness of 20 μm on the electrodeposition-coated sheet, and was preheated for 5 minutes to room temperature. This was then heated for 30 minutes to 100° C., giving a solvent-based colored coating film layer. The lightness L*45 value of the resulting solvent-based colored coating film layer was 85, as determined using the multi-angle spectrophotometer BYK-mac i (trade name, manufactured by BYK Gardner).

### Production Example 5: Production of Hydroxyl Group-Containing Acrylic Resin Solution A-1 for Top Coat Composition

To a four-neck flask equipped with a thermometer, reflux condenser, stirrer, and dropping funnel was charged 33.9 parts of xylene, which was heated while stirred in a nitrogen stream and maintained at 140° C. The following were then uniformly mixed therein at a temperature of 140° C. by being added dropwise at a constant rate via the dropping funnel over a period of 2 hours: radical polymerizable monomer (23.9 parts of 4-hydroxybutyl acrylate, 10.0 parts of styrene, 19.0 parts of isobutyl methacrylate, 6.2 parts of cyclohexyl methacrylate, and 0.9 part of methacrylic acid) and 5.0 parts of t-butyl peroxy-2-ethylhexanoate (as the polymerization initiator). After the dropwise addition of the materials had been completed, the contents were maintained for 1 hour at a temperature of 140° C., and the reaction temperature was then lowered to 110° C. 0.1 part of t-butyl peroxy-2-ethylhexanoate (polymerization initiator) was then dissolved in 1.0 part of xylene and added as additional catalyst, the temperature of 110° C. was maintained for another 2 hours, and the contents were then cooled, giving a hydroxyl group-containing acrylic resin solution A-1. The hydroxyl group-containing acrylic resin solution A-1 was characterized by a mass-average molecular weight of 7,000, an acid value of 9.8 mgKOH/g, a hydroxyl value of 155 mgKOH/g, a glass transition temperature of −10° C., and a resin solids content of 60%.

### Production Example 6: Production of Hydroxyl Group-Containing Acrylic Resin Solution A-2

To a four-neck flask equipped with a thermometer, reflux condenser, stirrer, and dropping funnel were charged 27.0 parts of xylene and 9.0 parts of propylene glycol monomethoxy ether acetate, which were heated while stirred in a nitrogen stream and maintained at 130° C. The following were then uniformly mixed therein at a temperature of 130° C. by being added dropwise at a constant rate via the dropping funnel over a period of 3 hours: radical polymerizable monomer (12.1 parts of 4-hydroxybutyl acrylate, 3.9 parts of 2-hydroxyethyl acrylate, 25.0 parts of styrene, 4.1 parts of isobutyl methacrylate, 9.1 parts of cyclohexyl methacrylate, and 0.8 part of methacrylic acid) and 1.0 part of t-butyl peroxy-2-ethylhexanoate (as the polymerization initiator). After the dropwise addition of the materials had been completed, the contents were maintained for 1 hour at a temperature of 130° C., and the reaction temperature was then lowered to 110° C. 0.1 part of t-butyl peroxy-2-ethylhexanoate (polymerization initiator) was then dissolved in 1.0 part of xylene and added as additional catalyst, the temperature of 110° C. was maintained for another 2 hours, and 6.9 parts of xylene was then added to thin the solution, which was cooled, giving a hydroxyl group-containing acrylic resin solution A-2. The hydroxyl group-containing acrylic resin solution A-2 was characterized by a mass-average molecular weight of 10,000, an acid value of 9.5 mgKOH/g, a hydroxyl value of 120 mgKOH/g, a glass transition temperature of 25° C., and a resin solids content of 55%.

### Production Example 7: Production of White Pigment Paste W-1

50.0 parts of the hydroxyl group-containing acrylic resin solution A-1 (as dispersion resin), 120.0 parts of the titanium dioxide pigment TIPAQUE CR-95 (trade name, manufactured by Ishihara Sangyo Co., Ltd.), and 50.0 parts of xylene were mixed and then dispersed using a Motormill, giving a white pigment paste W-1.

### Production Example 8: Production of White Pigment Paste W-2

54.5 parts of the hydroxyl group-containing acrylic resin solution A-2 (as dispersion resin), 120.0 parts of the titanium dioxide pigment TIPAQUE CR-95 (trade name, manufactured by Ishihara Sangyo Co., Ltd.), and 45.5 parts of xylene were mixed and then dispersed using a Motormill, giving a white pigment paste W-2.

### Production Example 9: Production of Yellow Pigment Paste Y-1

100.0 parts of the hydroxyl group-containing acrylic resin solution A-1 (as dispersion resin), 40.0 parts of the yellow iron oxide pigment TAROX LL-100 (trade name, manufactured by Titan Kogyo Ltd.), and 100.0 parts of xylene were mixed and then dispersed using a Motormill, giving a yellow pigment paste Y-1.

### Production Example 10: Production of Yellow Pigment Paste Y-2

109.1 parts of the hydroxyl group-containing acrylic resin solution A-2 (as dispersion resin), 40.0 parts of the yellow iron oxide pigment TAROX LL-100 (trade name, manufactured by Titan Kogyo Ltd.), and 90.9 parts of xylene were mixed and then dispersed using a Motormill, giving a yellow pigment paste Y-2.

### Production Example 11: Production of Black Pigment Paste B-1

100.0 parts of the hydroxyl group-containing acrylic resin solution A-1 (as dispersion resin), 20.0 parts of the perylene-based black pigment Paliogen Black L0086 (trade name, manufactured by DIC Corporation), and 100.0 parts of xylene were mixed and then dispersed using a Motormill, giving a black pigment paste B-1.

### Production Example 12: Production of Top Coat Compositions TC-1 Through TC-14

Of the raw materials listed in Table 1, the hydroxyl group-containing acrylic resin (A), resin beads (C), pigment pastes, and additive solutions (UV absorber solution, photostabilizer solution, and surface conditioner solution) were mixed and stirred to homogeneity. The polyisocyanate compound (B) listed in Table 1 was added to the mixtures, which were again stirred to homogeneity. The resulting mixtures were diluted with Solvesso 100 (noted as S-100 in Table 1) to a Ford #4 Cup viscosity of 25 seconds at 20° C., giving top coat compositions TC-1 through TC-14.

Solvesso 100 (trade name, manufactured by ExxonMobil) is an aromatic petroleum naphtha; the amount (parts by mass) of Solvesso 100 used to adjust each of the top coat compositions to the viscosity noted above is indicated in the S-100 row of Table 1.

TABLE 1
Formulations of top coat compositions TC-1 through TC-14

| | | TC-1 | TC-2 | TC-3 | TC-4 | TC-5 | TC-6 | TC-7 | TC-8 | TC-9 | TC-10 | TC-11 | TC-12 | TC-13 | TC-14 |
|---|---|---|---|---|---|---|---|---|---|---|---|---|---|---|---|
| (A) | Hydroxyl group- | 104.0 | 104.0 | 104.0 | | 104.0 | | 104.0 | 104.0 | 104.0 | 104.0 | 104.0 | 104.0 | 104.2 | 104.2 |
| | containing acrylic | | | | | | | | | | | | | | |
| | resin A-1 | | | | | | | | | | | | | | |
| | Hydroxyl group- | | | | 123.5 | | 123.5 | | | | | | | | |
| | containing acrylic | | | | | | | | | | | | | | |
| | resin A-2 | | | | | | | | | | | | | | |
| (B) | Desmodur N3300 1) | 34.7 | 34.7 | 34.7 | 29.2 | 34.7 | 29.2 | 34.7 | 34.7 | 34.7 | 34.7 | 34.7 | 34.7 | 34.7 | 34.7 |
| (C) | TECHPOLYMER | 20.0 | | | | | | | | | | | | | |
| | MBX-20 2) | | | | | | | | | | | | | | |
| | TAFTIC AR650MX 3) | | 20.0 | | | | | | | | | | | | |
| | TAFTIC AR650MZ 4) | | | 20.0 | 20.0 | | | | | | | | | 20.0 | |
| | ORGASOL 2002 | | | | | 20.0 | 20.0 | 10.0 | 30.0 | 50.0 | | | | | 20.0 |
| | ES6 NAT3 5) | | | | | | | | | | | | | | |
| | TECHPOLYMER | | | | | | | | | | 20.0 | | | | |
| | MBX-12 6) | | | | | | | | | | | | | | |
| | TAFTIC AR650ML 7) | | | | | | | | | | | 20.0 | | | |
| | Iriodin 103 WNT 8) | | | | | | | | | | | | 7.5 | | |

| | | | | | | | | | | | | | | |
|---|---|---|---|---|---|---|---|---|---|---|---|---|---|---|
| White pigment paste W-1 | 20.0 | 20.0 | 20.0 | | 20.0 | | 20.0 | 20.0 | 20.0 | 20.0 | 20.0 | 20.0 | 20.0 | 20.0 |
| White pigment paste W-2 | | | | 20.0 | | 20.0 | | | | | | | | |
| Yellow pigment paste Y-1 | 0.6 | 0.6 | 0.6 | | 0.6 | | 0.6 | 0.6 | 0.6 | 0.6 | 0.6 | 0.6 | | |
| Yellow pigment paste Y-2 | | | | 0.6 | | 0.6 | | | | | | | | |
| Black pigment paste B-1 | | | | | | | | | | | | | 0.2 | 0.2 |
| UV absorber solution 9) | 5.0 | 5.0 | 5.0 | 5.0 | 5.0 | 5.0 | 5.0 | 5.0 | 5.0 | 5.0 | 5.0 | 5.0 | 5.0 | 5.0 |
| Photostabilizer solution 10) | 5.0 | 5.0 | 5.0 | 5.0 | 5.0 | 5.0 | 5.0 | 5.0 | 5.0 | 5.0 | 5.0 | 5.0 | 5.0 | 5.0 |
| Surface conditioner solution 11) | 2.0 | 2.0 | 2.0 | 2.0 | 2.0 | 2.0 | 2.0 | 2.0 | 2.0 | 2.0 | 2.0 | 2.0 | 2.0 | 2.0 |
| S-100 | 7.0 | 7.0 | 7.0 | 1.0 | 7.0 | 1.0 | 6.0 | 8.0 | 16.0 | 7.0 | 7.0 | 5.0 | 6.0 | 6.0 |
| Total | 198.3 | 198.3 | 198.3 | 206.3 | 198.3 | 206.3 | 187.3 | 209.3 | 237.3 | 198.3 | 198.3 | 183.8 | 197.1 | 197.1 |

Numerical values in the table indicate parts by mass.
1) Desmodur N3300: trade name, manufactured by Sumika Covestro Urethane Co., Ltd.; hexamethylene diisocyanate (HDI) trimer; nonvolatile component content: 100% by mass; NCO content: 21.8% by mass
2) TECHPOLYMER MBX-20: trade name, manufactured by Sekisui Kasei Co., Ltd.; acrylic resin beads; D50 = 20 μm
3) TAFTIC AR650MX: trade name, manufactured by Japan Exlan Co., Ltd.; acrylic resin beads; D50 = 40 μm
4) TAFTIC AR650MZ: trade name, manufactured by Japan Exlan Co., Ltd.; acrylic resin beads; D50 = 60 μm
5) ORGASOL 2002 ES6 NAT3: trade name, manufactured by Arkema; polyamide resin beads; D50 = 60 μm
6) TECHPOLYMER MBX-12: trade name, manufactured by Sekisui Kasei Co., Ltd.; acrylic resin beads; D50 = 12 μm
7) TAFTIC AR650ML: trade name, manufactured by Japan Exlan Co., Ltd.; acrylic resin beads; D50 = 80 μm
8) Iriodin 103 WNT: trade name, manufactured by Merck Performance Materials Ltd.: interference pearl pigment
9) UV absorber solution: 20% by mass xylene solution of TINUVIN 900 (trade name, manufactured by BASF Japan)
10) Photostabilizer solution: 20% by mass xylene solution of TINUVIN 292 (trade name, manufactured by BASF Japan)
11) Surface conditioner solution: 10% by mass xylene solution of BYK-300 (trade name, manufactured by BYK Japan)

### Examples 1 through 10, and Comparative Examples 1 through 7

### (1) Preparation of Test Pieces

The cationic electrodeposition coating CathoGuard 500 (trade name, manufactured by BASF Japan) was applied via electrodeposition to a cured film thickness of 20 μm on zinc phosphate-treated mild steel sheets, and was baked for 25 minutes at 175° C., giving electrodeposition-coated sheets.

In Examples 1 through 8 and Comparative Examples 1 through 7, the water-based colored coating composition PR-1 was then spray-coated to a dry film thickness of 30 μm on the above electrodeposition-coated sheets, and was preheated for 5 minutes to 85° C. The sheets coated with the water-based colored coating composition PR-1 were then allowed to cool to room temperature, top coat compositions TC-1 through TC-12 were then spray-coated to the dry film thicknesses given in Table 2, and the pieces were allowed to stand for 10 minutes at room temperature. Lastly, the pieces were heated for 30 minutes to 100° C., giving test pieces.

In Examples 9 and 10, the solvent-based colored coating composition PR-2 was spray dried to a dry film thickness of 20 μm on the above electrodeposition-coated sheets and were allowed to stand for 5 minutes at room temperature, the top coat compositions TC-13 and TC-14 were then spray coated to the dry film thicknesses given in Table 2, and the pieces were allowed to stand for 10 minutes at room temperature. Lastly, the pieces were heated for 30 minutes to 100° C. to prepare multilayer coated film test pieces.

The details of the resin beads contained in each of the top coat compositions are given in Table 1, and Table 2 also shows the average particle size D50 of the resin beads in each of the top coat compositions.

Top coat composition TC-11 clogged the spray gun during the coating process, preventing any test pieces from being prepared.

### (2) Assessment of Multilayer Coating Film

The multilayer coating films (test pieces) obtained in Examples 1 through 10 and in Comparative Examples 1, 2, and 4 through 7 were assessed and analyzed per (2)-1 through (2)-5 below, and the results are presented in Table 2.

### (2)-1 Assessment of Differences in Lightness L*15−L*25

The lightness L*15 value and L*25 were measured using the multi-angle spectrophotometer BYK-mac i (trade name, manufactured by BYK Gardner) to calculate the difference in lightness L*15−L*25.

### (2)-2 Measurement of Infrared Reflectance (IRSR)

The infrared reflectance (IRSR) was measured using an ultraviolet/visible/near-infrared spectrophotometer UV-3600 (trade name, manufactured by Shimadzu Corporation).

### (2)-3 Measurement of Total Solar Reflectance (TSR)

The total solar reflectance (TSR) was measured using an ultraviolet/visible/near-infrared spectrophotometer UV-3600 (trade name, manufactured by Shimadzu Corporation).

### (2)-4 Assessment of Moisture Resistance

The resulting test pieces were allowed to stand for 240 hours in a thermo-hygrostat chamber set to 50° C. and 95% humidity. The test pieces were then taken out to visually assess the appearance of the coating films for abnormalities or blistering based on the following criteria.
O: Coating film free of abnormalities
X: Blistering or pronounced abnormalities in appearance

### (2)-5 Assessment of Weather Resistance

Tests were conducted for 3000 hours using a sunshine carbon arc lamp type of weather resistance tester (JISK-5400 (1990) 9.8.1), and the coating films were visually assessed after the tests.
O: Coating film free of abnormalities
X: Blistering or pronounced abnormalities in appearance

TABLE 2
Multilayer coating film configuration and assessment

| | | Example | Example | Example | Example | Example | Example | Example | Example |
|---|---|---|---|---|---|---|---|---|---|
| | | 1 | 2 | 3 | 4 | 5 | 6 | 7 | 8 |
| Colored coating film | Colored coating composition | PR-1 | PR-1 | PR-1 | PR-1 | PR-1 | PR-1 | PR-1 | PR-1 |
| | Dry film thickness (μm) | 30 | 30 | 30 | 30 | 30 | 30 | 30 | 30 |
| | Lightness L*45 | 87 | 87 | 87 | 87 | 87 | 87 | 87 | 87 |
| Top coat film | Top coat composition | TC-1 | TC-2 | TC-3 | TC-4 | TC-5 | TC-6 | TC-7 | TC-8 |
| | Resin bead D50 (μm) | 20 | 40 | 60 | 60 | 60 | 60 | 60 | 60 |
| | Curing temperature (° C.) | 100 | 100 | 100 | 100 | 100 | 100 | 100 | 100 |
| | Dry film thickness (μm) | 15 | 30 | 40 | 40 | 40 | 40 | 40 | 40 |
| Multilayer coating film | Lightness L*15 | 98.1 | 97.9 | 95.2 | 95.4 | 95.1 | 95.2 | 95.2 | 94.5 |
| | Lightness L*25 | 90.7 | 90.9 | 90.5 | 90.6 | 90.2 | 90.2 | 90.3 | 89.8 |
| | Difference in lightness | 7.4 | 7.0 | 4.7 | 4.8 | 4.9 | 5.0 | 4.9 | 4.7 |
| | L*15 − L*25 | | | | | | | | |
| | Infrared reflectance (IRSR) | 65.9 | 66.3 | 66.6 | 66.9 | 66.5 | 67.1 | 66.5 | 66.7 |
| | Total solar reflectance (TSR) | 67.1 | 67.7 | 67.9 | 68.3 | 67.9 | 68.2 | 67.8 | 68.1 |
| | Weather resistance | ∘ | ∘ | ∘ | ∘ | ∘ | ∘ | ∘ | ∘ |
| | Moisture resistance | ∘ | ∘ | ∘ | ∘ | ∘ | ∘ | ∘ | ∘ |

| | | Example | Example | Comparative | Comparative | Comparative |
|---|---|---|---|---|---|---|
| | | 9 | 10 | Example 1 | Example 2 | Example 3 |
| Colored coating film | Colored coating composition | PR-2 | PR-2 | PR-1 | PR-1 | PR-1 |
| | Dry film thickness (μm) | 20 | 20 | 30 | 30 | 30 |
| | Lightness L*45 | 88 | 88 | 87 | 87 | 87 |
| Top coat film | Top coat composition | TC-13 | TC-14 | TC-9 | TC-10 | TC-11 |
| | | | | | | (※) |
| | Resin bead D50 (μm) | 60 | 60 | 60 | 12 | 80 |
| | Curing temperature (° C.) | 100 | 100 | 100 | 100 | — |
| | Dry film thickness (μm) | 40 | 40 | 40 | 10 | — |
| Multilayer coating film | Lightness L*15 | 90.3 | 90.4 | 94.2 | 98.2 | — |
| | Lightness L*25 | 85.1 | 84.8 | 89.6 | 97.4 | — |
| | Difference in lightness | 5.2 | 5.6 | 4.6 | 0.8 | — |
| | L*15 − L*25 | | | | | |
| | Infrared reflectance (IRSR) | 67.5 | 67.6 | 66.8 | 65.5 | — |
| | Total solar reflectance (TSR) | 64.1 | 64.3 | 68.2 | 66.8 | — |
| | Weather resistance | ∘ | ∘ | X | ∘ | — |
| | Moisture resistance | ∘ | ∘ | X | ∘ | — |

| | | Comparative | Comparative | Comparative | Comparative |
|---|---|---|---|---|---|
| | | Example 4 | Example 5 | Example 6 | Example 7 |
| Colored coating film | Colored coating composition | PR-1 | PR-1 | PR-1 | PR-1 |
| | Dry film thickness (μm) | 30 | 30 | 30 | 30 |
| | Lightness L*45 | 87 | 87 | 87 | 87 |
| Top coat film | Top coat composition | TC-12 | TC-1 | TC-2 | TC-3 |
| | Resin bead D50 (μm) | — | 20 | 40 | 60 |
| | Curing temperature (° C.) | 100 | 100 | 100 | 100 |
| | Dry film thickness (μm) | 40 | 30 | 50 | 70 |
| Multilayer coating film | Lightness L*15 | 95.9 | 98.2 | 98.0 | 97.6 |
| | Lightness L*25 | 90.9 | 97.5 | 97.5 | 97.2 |
| | Difference in lightness | 5.0 | 0.5 | 0.6 | 0.7 |
| | L*15 − L*25 | | | | |
| | Infrared reflectance (IRSR) | 66.5 | 65.7 | 65.7 | 65.5 |
| | Total solar reflectance (TSR) | 68.0 | 68.1 | 67.8 | 67.6 |
| | Weather resistance | X | ∘ | ∘ | ∘ |
| | Moisture resistance | X | ∘ | ∘ | ∘ |

(*) The spray gun became clogged during the coating process, preventing any test pieces from being prepared.

Inventions produced by the present inventors have been described in detail based on embodiments, but the present invention is not limited to these embodiments, and it will be obvious that the invention can be modified in a variety of ways within the scope of the present invention.

### LEGEND FOR SYMBOLS

10: Multilayer coating film
F: Surface of multilayer coating film
PL: Perpendicular line to the surface of the multilayer coating film
I: Incident light
R_{I}: Incident angle
SR: Specularly reflected light
R_{SR}: Angle of specular reflection
L₁₅: Reflected light (light reflected at 15 degree angle (incident light direction) relative to the angle of specular reflection R_{SR})
L₂₅: Reflected light (light reflected at 25 degree angle (incident light direction) relative to the angle of specular reflection R_{SR})

1. A method for forming a multilayer coating film, comprising:
Step (1): a step in which a colored coating composition that contains a color pigment is applied onto an object being coated to form a colored coating film layer;
Step (2): a step in which a luster pigment-free top coat composition that contains a hydroxyl group-containing acrylic resin (A), a polyisocyanate compound (B), and resin beads (C) is applied onto the colored coating film layer to form a top coat layer; and
Step (3): a step in which the colored coating film layer formed in Step (1) and the top coat layer formed in Step (2) are cured by being heated, either separately or simultaneously, wherein
the average particle size D50 of the resin beads (C) is 20 to 70 μm,
the dry film thickness of the top coat layer is equal to or less than the average particle diameter D50 of the resin beads (C), and
the difference between the L*15 value and the L*25 value (L*15−L*25) is 1.0 to 20.0, where the L*15 value indicates lightness, per a CIE LAB color system, based on the spectral reflectivity of reflected light, where the incident light landing at a 45 degree angle relative to the perpendicular line to the surface of the resulting multilayer coating film is measured at a 15 degree angle (incident light direction) relative to the angle of specular reflection, and the L*25 value indicates lightness, per the CIE LAB color system, based on the spectral reflectivity of reflected light, where the incident light landing at a 45 degree angle relative to the perpendicular line to the surface of the resulting multilayer coating film is measured at a 25 degree angle (incident light direction) relative to the angle of specular reflection.

2. The method for forming a multilayer coating film according to claim 1, wherein the total content of the resin beads (C) in the top coat composition is 5 to 40 parts by mass per 100 parts by mass of the total non-volatile components of the hydroxyl-containing acrylic resin (A) and the polyisocyanate compound (B).

3. The method for forming a multilayer coating film according to claim 1, wherein the top coat composition contains a color pigment.

4. The method for forming a multilayer coating film according to claim 1, wherein the top coat layer is cured by being heated to between 7° and 150° C.

5. The method for forming a multilayer coating film according to claim 1, wherein the L*45 value of the colored coating film layer is 70 to 95, and the infrared reflectance (IRSR) of the resulting multilayer coating film is 60% or more.

6. A multilayer coating film formed by the method for forming a multilayer coating film according to claim 1.
